(19) United States
(12) Patent Application Publication
(10) Pub. No.: US 2009/0009810 A1
(43) Pub. Date: Jan. 8, 2009

(54) IMAGE FORMING APPARATUS, IMAGE FORMING METHOD, IMAGE FORMING PROGRAM, AND RECORDING MEDIUM

(76) Inventors: YOSHIMUNE NODA, NARA-SHI (JP); MIKIYA OKADA, NARA-SHI (JP)

Correspondence Address: BIRCH STEWART KOLASCH & BIRCH, PO BOX 747, FALLS CHURCH, VA, 22040-0747, US

(21) Appl. No.: 12/163,582

(22) Filed: Jun. 27, 2008

(30) Foreign Application Priority Data
Jul. 2, 2007 (JP) 2007-174207

(51) Int. Cl. G06K 15/00; G06F 3/12; G06F 15/00; G06K 15/02

(52) U.S. Cl. 358/1.18; 358/1.13; 358/1.2

(57) ABSTRACT

An image forming apparatus includes a reading means for reading image data of an original to be read, an area specifying means for specifying an image area from the read image data, a printing means for printing the image data, a post-processing means for subjecting recording paper to post-processing after completion of printing, and a control means for controlling each of the aforementioned means. Here, when post-processing is requested, the control means after reading the image data of the entire original by the reading means specifies the image area of the read image data by the area specifying means and judges whether or not the specified image area overlaps a gutter area.

This application claims priority under 35 U.S.C. §119(a) of Japanese Patent Application No. 2007-174207 filed in Japan on Jul. 2, 2007, the entire contents of which are herein incorporated by reference.

### BACKGROUND OF THE INVENTION

### Field of the Invention

The present invention relates to an image forming apparatus, an image forming method, an image forming program and a recording medium, wherein a post-processing means performs post-processing to recording paper after completion of printing, and in particular, relates to an image forming apparatus, an image forming method, an image forming program and a recording medium which perform optimum print processing while securing a gutter area when post-processing is requested upon printing.

Conventional image forming apparatuses provided with a post-processing means are designed to secure a gutter area when the provision of stapling or punching is instructed upon printing, by uniformly scaling down image data regardless of the image data to be printed so that the gutter area can be secured (for example, see JP H11-99724A and JP 2003-211772A).

Usually, even when instructing the provision of stapling or punching, users prefer printing to be performed without any resealing unless intentionally specifying otherwise. However, when the provision of stapling or punching is instructed, conventional image forming apparatuses as mentioned above automatically scale down read image data regardless of the users' will, and therefore users may sometimes feel confused or uncomfortable because it seems to the users that the size is automatically changed. That is, it appears to users that the entire image data (all pages) is scaled down even when the users think it is sufficient that only when a gutter area and an image area overlap, the overlapping image data (specific pages) or the entire image data (all pages) should be scaled down, or even when the users wish to print the entire image data (all pages) without scaling down even if that creates some image loss.

### SUMMARY OF THE INVENTION

The present invention was made in view of the situation described above, and it is an object of the present invention to provide an image forming apparatus, an image forming method, an image forming program and a recording medium with which a user can choose whether or not the image to be printed needs to be scaled down depending on whether or not the gutter area and the image to be printed overlap.

The image forming apparatus of the present invention is an image forming apparatus comprising a reading means for reading image data of an original to be read; an area specifying means for specifying an image area from the read image data; a printing means for printing the image data; a post-processing means for subjecting recording paper to post-processing after completion of printing; and a control means for controlling each of the aforementioned means, wherein when post-processing is set, after reading the image data of the entire original by the reading means, the control means specifies the image area of the read image data by the area specifying means and judges whether or not the specified image area overlaps a gutter area.

In such a configuration, when post-processing is requested, by judging whether or not a gutter area is secured after reading all the original without immediately performing scale-down processing, a printing process can be performed without scaling down the image data when the gutter area and the original image do not overlap. Therefore, a problem can be prevented such as making users uncomfortable or confused by unnecessarily printing the original at a reduced size when post-processing is requested.

Moreover, in the image forming apparatus according to the present invention, the original to be read may be a double-sided original.

Furthermore, in the image forming apparatus according to the present invention, the control means may be configured to output a message indicating this by an informing means when the gutter area and the image area overlap. Thus, when a gutter area and an image area overlap, printing at a reduced size is not performed automatically, but first a user is informed of the presence of an overlapping portion, thereby enabling the user to choose in this instance reduced-size printing or printing in another manner (e.g., actual-size printing and or the like).

In other words, the image forming apparatus according to the present invention may be equipped with a first selecting means which allows, when the gutter area and the image area overlap, a user to choose whether or not all pages of the read image data are subjected to actual-size printing, and the control means may be configured to print all pages of the image data at an actual size when actual-size printing is selected with the first selecting means.

Thus, even when a gutter area and an image area overlap, when a user decides that some overlapping is acceptable, all the pages of image data can be subjected to actual-size printing according to the user's will.

Moreover, the image forming apparatus according to the present invention may be equipped with a second selecting means which allows, when the gutter area and the image area overlap, a user to choose whether all pages of the read image data are subjected to reduced-size printing or only the overlapping page(s) are subjected to reduced-size printing, and the control means may be configured to print all the pages of the image data at a reduced size, or print the page(s) that overlap at a reduced size and print the page(s) that do not overlap at an actual size, according to a result of selection with the second selection means.

Thus, it is also possible that only the image data of the pages on which the gutter area and the image area overlap is printed at a reduced size and the image data of the other pages is printed at an actual size (100% printing).

In this case, the image forming apparatus according to the present invention may be configured to indicate a reduction percentage on a page (recording paper) of the image data printed at the reduced-size. Due to this configuration, a user is able to know how scaled-down the image data of a given page is. Therefore, when printing is to be performed in which the reduction percentage of this page only is changed by a manual setting, a more precise reduction percentage can be set with reference to the displayed reduction percentage.

Furthermore, the image forming method of the present invention is an image forming method comprising a reading step of reading by a reading means image data of an original to be read; a specifying step of specifying by an image-area specifying means an image area from the read image data; a printing step of printing by a printing means the image data; a post-processing step of subjecting, by a post-processing apparatus, recording paper to post-processing after completion of printing; and a judging step, wherein when post-processing is requested, before the post-processing step is performed, the image data of the entire original is read in the reading step, the image area of the read image data is specified in the specifying step, and it is judged in the judging step whether or not on the specified image area overlaps a gutter area.

In such a configuration, even with an original for which post-processing is requested, by judging whether or not a gutter area is secured after reading all the original without immediately performing scale-down processing, a printing process can be performed without scaling down the image data when the gutter area and the original image do not overlap. Therefore, a problem can be prevented such as making users uncomfortable or confused by unnecessarily printing the original at a reduced size when post-processing is requested.

Furthermore, the aforementioned image forming method can be embodied as an image forming program so as to have a computer execute all the steps thereof and the image forming program can be recorded for distribution on a computer readable recording medium.

### BRIEF DESCRIPTION OF THE DRAWINGS

FIG. 1 is an outline view of the digital multifunction machine according to one embodiment of the image forming apparatus of the present invention.

FIG. 2 is an outline cross-sectional view of the digital multifunction machine according to one embodiment of the image forming apparatus of the present invention.

FIG. 3 is a block diagram showing the configuration of the control system in a digital multifunction machine.

FIG. 4a is an explanatory diagram showing an example of a manner of post-processing by stapling.

FIG. 4b is an explanatory diagram showing another example of a manner of post-processing by stapling.

FIG. 4c is an explanatory diagram showing yet another example of a manner of post-processing by stapling.

FIG. 5a is an explanatory diagram showing an example of a manner of post-processing by punching.

FIG. 5b is an explanatory diagram showing another example of a manner of post-processing by punching.

FIG. 6 is a flow chart depicting a printing process control action when post-processing is requested upon printing.

FIG. 7 is an explanatory drawing showing an example of displaying a message on a console panel.

### DESCRIPTION OF THE PREFERRED EMBODIMENTS

Hereinafter, embodiments of the present invention are described with reference to the drawings.

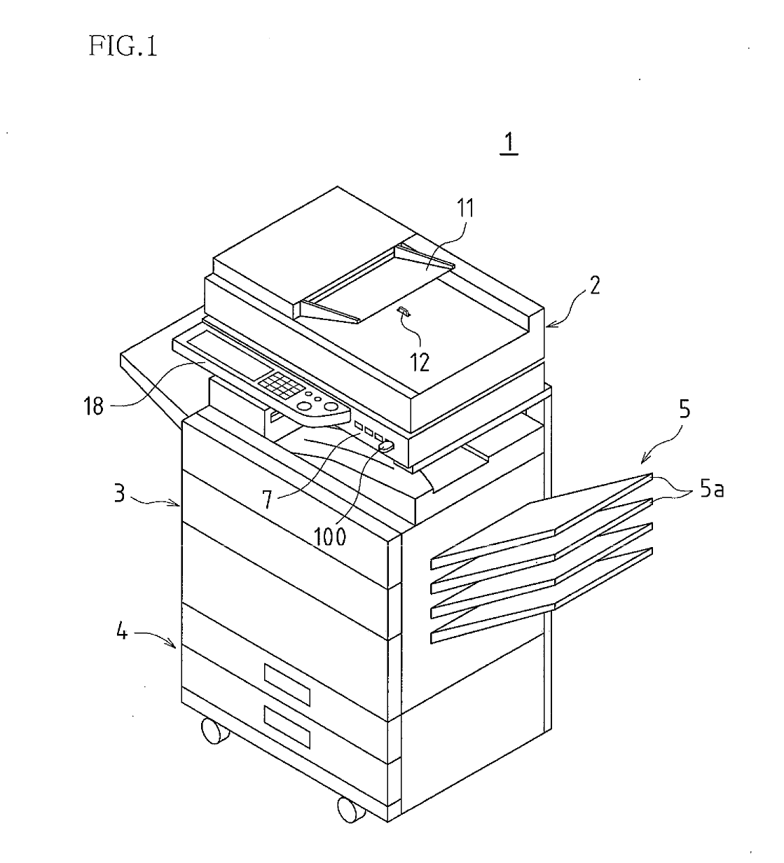

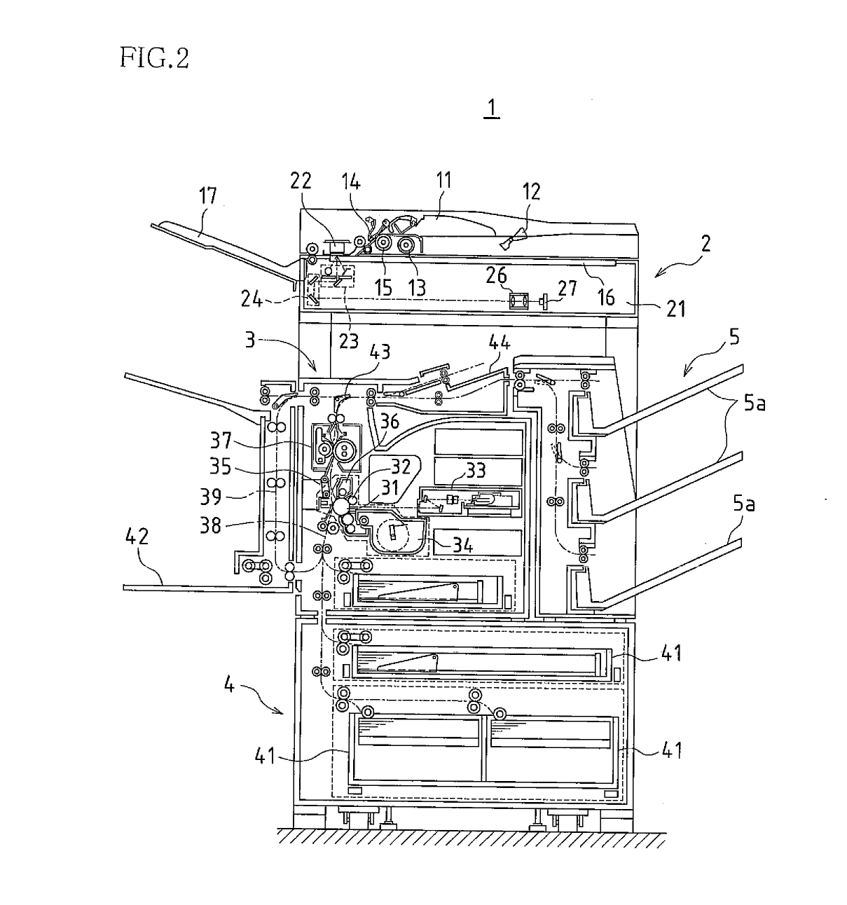

FIG. 1 and FIG. 2 are an outline view and an outline cross-sectional view, respectively, of a digital multifunction machine, which is an embodiment of the image forming apparatus of the present invention. First, in reference to FIG. 1 and FIG. 2, the digital multifunction machine of the present embodiment is described.

A digital multifunction machine 1 is configured to selectively use a copier mode in which an image of an original is read and printed on recording paper; a facsimile mode in which an image of an original is read and sent or an image of an original is received and printed on recording paper; or a printer mode in which an image received via a network from a data terminal unit is printed on recording paper. When the components thereof are roughly classified, the digital multifunction machine 1 is composed of an original transport/read unit 2, an image forming unit 3, a paper feed unit 4, a paper discharge/processing unit 5, and USB interfaces 7. As described below in detail, the original transport/read unit 2 is designed to include a reading means for reading image data of an original, the image forming unit 3 is designed to include a printing means for printing the image data, and the paper discharge/processing unit 5 is designed to include a post-processing means for subjecting the recording paper to post-processing after completion of printing.

Next, using the aforementioned copier mode as an example, the configuration of the original transport/read unit 2, the image forming unit 3, the paper feed unit 4, and the paper discharge/processing unit 5 as well as their function are described.

First, when an original is placed on an original placement tray 11 of the original transport/read unit 2, an original detection sensor 12 detects placement of the original. Then, a user inputs settings for the size of printing paper, scaling factor and the like by operating a console panel 18 of the original transport/read unit 2. Then, an instruction to start copying is given through the operation of the console panel 18.

In response to these operations, in the original transport/read unit 2, a pickup roller 13 draws out, one sheet at a time, the original placed on the original placement tray 11. The drawn-out original is forwarded between a separating board 14 and a conveying roller 15 onto a glass platen 16, and the original is moved in the sub-scanning direction (leftward in FIG. 2) on the glass platen 16 and discharged onto an original discharge tray 17.

In this instance, the front surface (lower surface) of the original is read by a first read unit 21. That is, a first scanning unit 23 of the first read unit 21 is positioned by being moved to the home position (moved to the position shown in FIG. 2). Then, after positioning a second scanning unit 24 at a specific position, the front surface of the original is irradiated through the glass platen 16 by an exposing lamp of the first scanning unit 23; the light reflected from the original is directed to an imaging lens 26 by reflecting mirrors of the first and second scanning units 23 and 24; and the light reflected from the original is focused onto a CCD (Charge Coupled Device) 27 by the imaging lens 26, thereby recreating on the CCD 27 the image on the front surface of the original. Thus, the image on the surface of the original is read.

Furthermore, the back surface (upper surface) of the original is read by a second read unit 22. The second read unit 22 is disposed above the glass platen 16, and although not shown in the figures, is equipped with an exposing lamp (LED (light emitting diode) array, fluorescent light, or the like) which irradiates the back surface of the original, a SELFOC lens array which collects the light reflected from the original with respect to each pixel, and a contact image sensor (CIS) which outputs analog image signals after the photoelectric conversion of the light reflected from the original which is received through the SELFOC lens array.

It is also possible to open the upper housing of the original transport/read unit 2, place an original over the glass platen 16, and read the front surface of the original in this state by the first read unit 21. In this case, the first and second scanning units 23 and 24 are moved in the sub-scanning direction (rightward in FIG. 2) while maintaining a specific speed relationship between each other, the original on the glass platen 16 is irradiated by the first scanning unit 23, the light reflected from the original is directed to the imaging lens 26 by the first and second scanning units 23 and 24, and the image on the original is recreated on the CCD 27 by the imaging lens 26.

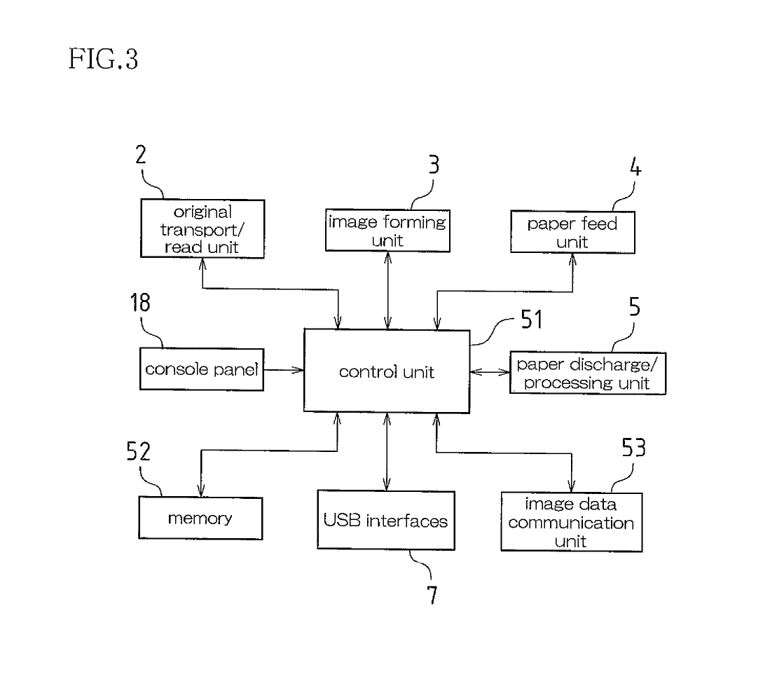

After one or both surfaces of the original are read in this way, image data representing the image presented on one or both sides of the original is entered into a control unit 51 (shown in FIG. 3). Here, various types of image processing are performed to the image data, and the image data are outputted into the image forming unit 3.

The image forming unit 3 is for printing on recording paper the image of the original which is represented by the image data, and is equipped with a photosensitive drum 31, a charging apparatus 32, a laser scanning unit (hereinafter referred to as LSU) 33, a development apparatus 34, a transfer apparatus 35, a cleaning apparatus 36, a charge removal apparatus (not shown), a fixing apparatus 37, etc.

Moreover, a main transport path 38 and a reverse transport path 39 are disposed in the image forming unit 3. Recording paper delivered from the paper feed unit 4 travels through the main transport path 38. The paper feed unit 4 draws out, one sheet at a time, the recording paper which is stored in a paper cassette 41 or placed on a manual feed tray 42 and forwards the drawn-out recording paper into the main transport path 38 of the image forming unit 3.

While the recording paper is being conveyed through the main transport path 38 of the image forming unit 3, the recording paper travels between the photosensitive drum 31 and the transfer apparatus 35 and through the fixing apparatus 37, thereby printing on the recording paper.

The photosensitive drum 31 rotates in one direction. Its surface is cleaned by the cleaning apparatus 36 and the charge removal apparatus, and the surface is then uniformly charged with the charging apparatus 32. The laser scanning unit 33 modulates laser light based on the image data provided from the original transport/ read unit 2, repeatedly scans in the main scanning direction (direction perpendicular to the surface of the paper in FIG. 2) the surface of the photosensitive drum 31 with the laser light, thereby forming an electrostatic latent image on the surface of the photosensitive drum 31. The development apparatus 34 supplies toner to the surface of the photosensitive drum 31, develops the electrostatic latent image, and forms a toner image on the surface of the photosensitive drum 31. The transfer apparatus 35 transfers the toner image created on the surface of the photosensitive drum 31 onto the recording paper traveling between the transfer apparatus 35 and the photosensitive drum 31. The fixing apparatus 37 heats and pressurizes the recording paper and fixes the toner image transferred onto the recording paper.

A branch catch 43 is disposed at the location where the main transport path 38 and the reverse transport path 39 meet. When printing is performed only on one surface of recording paper, the branch catch 43 is positioned as shown in FIG. 2, and the recording paper discharged from the fixing apparatus 37 is guided by the branch catch 43 in the direction of a discharge tray 44 or the paper discharge/processing unit 5.

Moreover, when printing is performed on both surfaces of the recording paper, the branch catch 43 is rotated (in FIG. 2, rotated substantially 90 degrees to the right), and the recording paper is guided in the direction of the reverse transport path 39. The recording paper guided into the reverse transport path 39 travels through the reverse transport path 39 and its front and back are inverted, and the recording paper is then delivered again into the main transport path 38. While traveling through the main transport path 38 for the second time, printing is performed on the back surface and the recording paper is then guided in the direction of the discharge tray 44 or the paper discharge/processing unit 5. That is, the recording paper is discharged onto either the discharge tray 44 or one of the discharge trays 5a of the paper discharge/processing unit 5.

The paper discharge/processing unit 5 sorts a plurality of sheets of the recording paper for discharge into discharge trays 5a. Moreover, the paper discharge/processing unit 5 is equipped with a post-processing apparatus which performs punching or stapling of the sheets of the recording paper For example, when making a plurality of copies of a printed material, the sheets of the recording paper are sorted for discharge onto each discharge tray 5a so that one copy of the printed material is allocated to one discharge tray 5a, and at every discharge tray 5a, punching or stapling is performed onto the sheets of the recording paper on the discharge trays 5a, thereby obtaining a plurality of copies of the printed matter. Such post-processing performed in the paper discharge/processing unit 5 is also controlled by the control unit 51. The above is a description of the processing operation in the copier mode.

FIG. 3 is a block diagram showing a configuration of the control system in the digital multifunction machine 1 having the above-described makeup. Hereinbelow, the configuration of the control system is described with reference to FIG. 3.

The control unit 51 composed of a microcomputer or the like manages by sequence control each drive mechanism unit constituting the digital multifunction machine 1, such as the original transport/read unit 2, the image forming unit 3, the paper feed unit 4 and the paper discharge/processing unit 5. The control unit 51 is connected to the console panel 18 so as to be able to communicate mutually, and has the digital multifunction machine 1 operate according to the printing process settings inputted by a user through the operation of the console panel 18. The console panel 18 has a structure in which a transparent touch panel is overlaid on top of a display panel such as a liquid crystal panel or the like. By pressing various feature buttons displayed on the console panel 18, instruction signals corresponding to the feature buttons are inputted into the control unit 51.

Furthermore, to the control unit 51 are connected a memory 52, USB interfaces 7 and an image data communication unit 53. A variety of control information necessary for controlling each drive mechanism unit constituting the digital multifunction machine 1 is stored in the memory 52. Furthermore, a USB memory 100 which is an external memory is connectable to and removable from a USB interface 7. The image data communication unit 53 is a communication unit provided in order to enable communication of image information, image control signals, etc., with other data terminal units.

The control unit 51 performs control of print processing according to the print processing settings that a user inputs through the operation of the console panel 18. In this instance, if post-processing such as stapling, punching or the like is requested, the control unit 51 is configured to specify, after the image data provided on the entire original is read by the original transport/read unit 2, the image area of the read image data, judge whether or not the specified image area overlaps a gutter area, and control the subsequent print processing according to the outcome of the judgment. That is, the area specifying means and control means set forth in the claims are realized in this embodiment by the control unit 51.

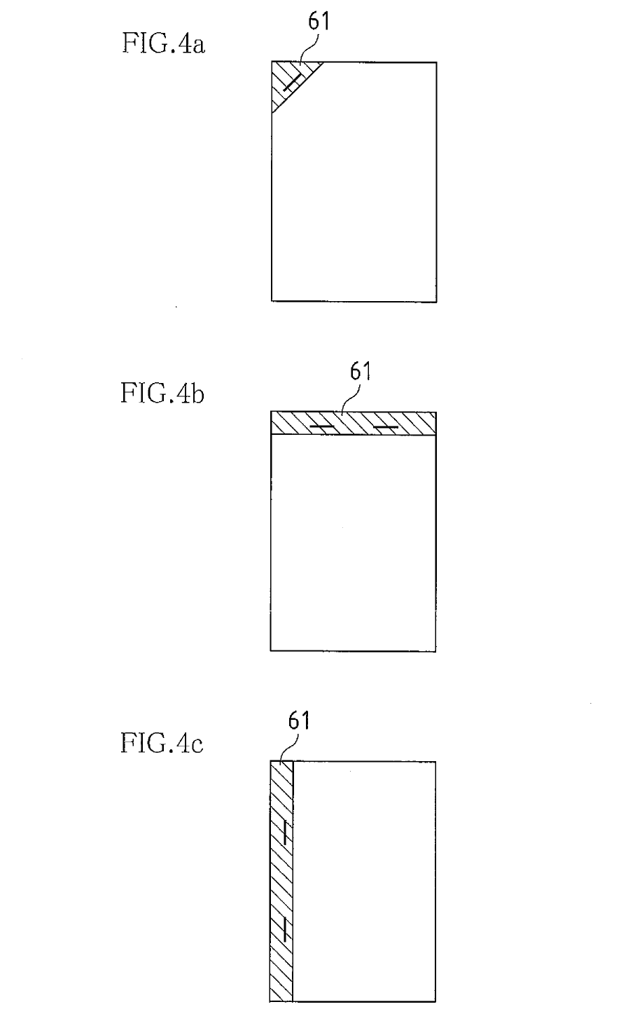

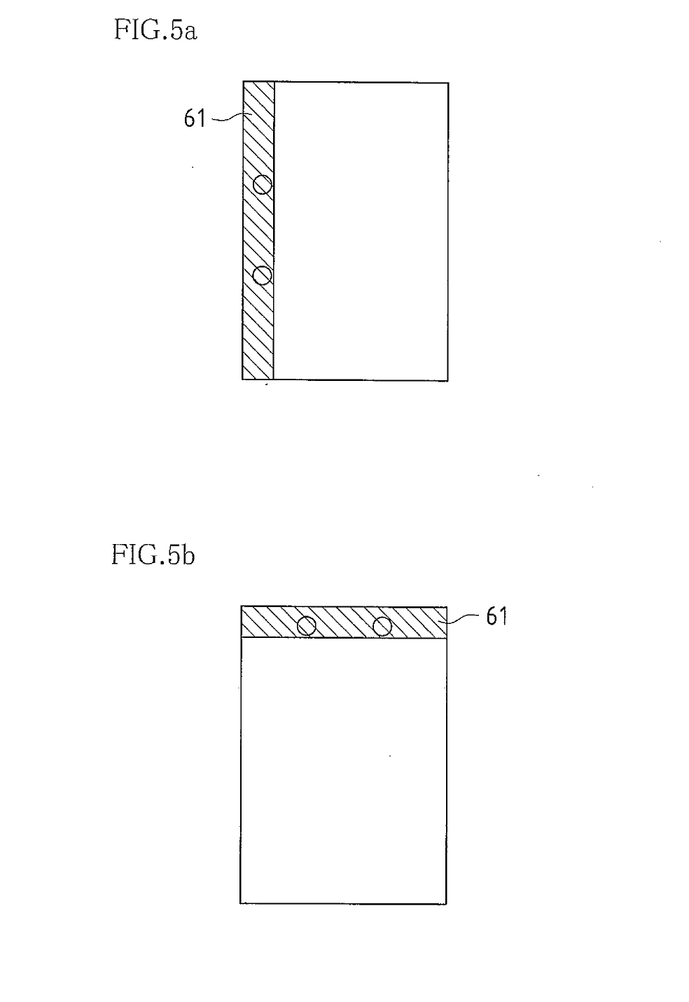

FIG. 4 shows manners of post-processing by stapling. It is possible to staple on the upper left-hand side (FIG. 4(a)), upper part (FIG. 4(b)), or left-hand side (FIG. 4(c)) of recording paper. In addition, FIG. 5 shows examples of manners of post-processing by punching. It is possible to punch on the left-hand side (FIG. 5(a)) or upper part (FIG. 5(b)) of recording paper. The number of punch holes provided on the left-hand side can be selected to be 2, 4 or 8.

Thus, in order to perform post-processing such as stapling, punching or the like, it is necessary to secure a gutter area 61 as indicated by the diagonal lines in FIG. 4 and FIG. 5. Therefore, when printing read image data on recording paper, printing is usually performed with suitable scale-down processing so that the image data is not present at the gutter area 61. In this case, conventional digital copiers when post-processing such as stapling, punching or the like is requested in the conventional digital copiers, image data is unconditionally scaled down in printing the image data. A feature of the present invention, however is in the print processing in this instance.

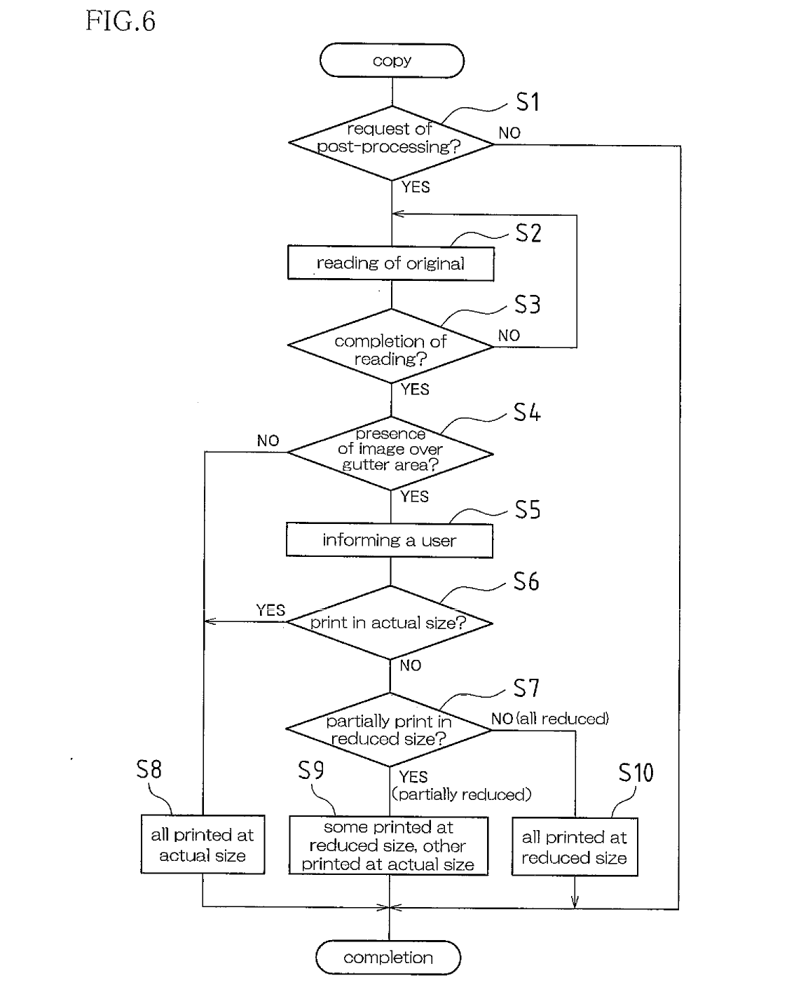

Hereinbelow, the print processing control action when post-processing is requested upon printing is described with reference to the flow chart shown in FIG. 6.

Prior to copying, a user sets the position and number of stapling or punching performed by the paper discharge/processing unit 5 (Step S1).

When the post-processing is requested(when judged as Yes in Step S1), the entire original placed on the original transport/read unit 2 is read (Steps S2 and S3), and in view of the read image data, whether or not any image data is present within the requested gutter area 61 is verified (Step S4). Based on this verification, when some image data is present within the gutter area 61 (i.e., when the image data area partially overlaps the gutter area), although it is possible to uniformly scale down the entire image data so that no image is present within the gutter area, since there are some users who do not prefer reduced-size printing, in this embodiment therefore, when it is necessary to secure the gutter area 61 by scaling down the image data (when judged as Yes in Step S4), a user is so informed prior to printing (Step S5). This informing can be carried out by displaying a message on the console panel 18. The informing can be carried out also with a buzzer sound or the like. In this example, the informing for informing of overlapping of the gutter area 61 and the image data area is realized by the control unit 51 which controls the console panel 18.

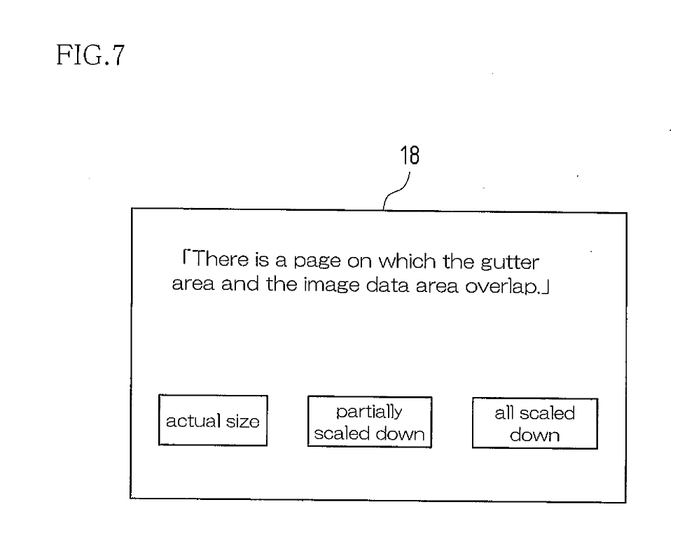

FIG. 7 shows an example of displayed information when a message is displayed on the console panel 18.

In this example, it is possible to display a simple message such as “there is a page on which the gutter area and the image data area overlap” as well as more specifically the number of pages such as “the total number of pages on which the gutter area and the image data area overlap is X” or “the image data on page X and page Y overlap the gutter area”. In this case, displaying an “actual size” button, a “partially scaled down” button and an “all scaled down” button below such a message lets a user select a print configuration.

In this embodiment, the first selecting means, which allows a user to determine whether or not all the pages of the read image data are printed at an actual size when the gutter area 61 and the image data area overlap, and the second selecting means, which allows a user to determine whether all the pages of the read image data are printed at a reduced size or only the overlapping pages are printed at a reduced size when the gutter area 61 and the image data area overlap, are realized by the control unit 51 which controls the console panel 18.

When a user, after acknowledging the information, accepts some overlapping, the user should press the “actual size” button displayed on the console panel 18 (when deciding Yes in Step S6). Thereby, the control unit 51 initiates processing in which all the image data of the read original is printed at an actual size (Step S8).

In addition, when a user, after acknowledging the information, wishes to print at a reduced size only the overlapping portion of the image data and wishes to print the rest of the image data at an actual size, the user should press the “partially scaled down” button displayed on the console panel 18 (when deciding Yes in Step S7). Thereby, the control unit 51 performs processing in which only the overlapping portion of the image data of the read original is printed at a reduced size and the rest of the image data is printed at an actual size (Step S9). The reduction percentage in this instance is such that the overlapping part of the image data is placed outside the gutter area, and it is automatically determined by the control unit 51. When reduced-size printing is performed, the reduction percentage may be displayed at a corner of the pages on which reduced-size printing is performed (for example, on the upper right corner, lower right corner, or the like). Thereby, the user can recognize how much the image data has been scaled down by checking the displayed numerical value that indicates the reduction percentage.

In addition, when a users after acknowledging the information, wishes to give priority to the uniformity in size of the image data, the user should press the “all scaled down” button displayed on the console panel 18 (when deciding No in Step S7). Thereby, the control unit 51 performs processing in which all the image data of the read original is printed at a reduced size (Step S1). The reduction percentage in this instance is such that the overlapping portion of the image data is placed outside the gutter area, and it is automatically determined by the control unit 51. When reduced-size printing is performed, the reduction percentage may be displayed at a corner of each page (for example, on the upper right corner, lower right corner, or the like) or the first page only. Thereby, the user can recognize how much the image data has been scaled down by checking the displayed numerical value that indicates the reduction percentage.

When no image data is present on the gutter area 61 as is verified in Step S4 (that is, when the image data area and the gutter area do not overlap), processing is advanced to Step S8, and the control unit 51 performs processing in which all the image data of the read original is printed at the actual size.

Even when the provision of a gutter is requested, the above-described configuration enables, without reduced-size printing being uniformly performed, actual-size printing or reduced-size printing to be selected as a user wishes. Moreover, in printing at a reduced size, indicating the reduction percentage thereof enables even a user with little knowledge of copying machines to set a gutter very conveniently.

The program for carrying out the above-described processing flow as shown in FIG. 6 can be stored in a computer-readable recording medium. The program is stored in the memory 52 in this embodiment. As examples of such recording media, a memory for processing with a microcomputer, such as a ROM, may be the program medium, or the recording media may be program media provided with a program reading device as an external storage device, not shown, wherein the recording medium is inserted and can be read.

In any case, it is preferable that the stored program is configured such that a microcomputer can access the program and execute it. Furthermore, a system is preferable in which the program is read, the read program is downloaded to a program storing area of the microcomputer, and the program is then executed. A program for this downloading should be stored in advance in the main device.

Further, the program media above may be recording media configured separably from a main device, and may be media which can fixedly support a program including tape-based media such as magnetic tape and cassette tape, disk-based media such as flexible disks, hard disks and like magnetic disk-based media and CDs, MOs, MDs, and DVDs, card-based media such as IC cards (including memory cards), or semiconductor memory using mask ROM, EPROM, EEPROM, or flash ROM.

Moreover, if the system configuration allows a connection with communication networks including the Internet, it is preferable that the recording medium supports a program flexibly by downloading it from a communication network.

Furthermore, when the program is downloaded from a communication network as described above, it is preferable that a program for this downloading is stored in advance in the main device or installed from a separate recording medium.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

1. An image forming apparatus comprising:
a reading means for reading image data of an original to be read;
an area specifying means for specifying an image area from the read image data;
a printing means for printing the image data;
a post-processing means for subjecting recording paper to post-processing after completion of printing; and
a control means for controlling each of the aforementioned means,
wherein, when post-processing is set, after reading the image data of the entire original by the reading means, the control means specifies the image area of the read image data by the area specifying means and judges whether or not the specified image area overlaps a gutter area.

2. The image forming apparatus according to claim 1, wherein the original to be read is a double-sided original.

3. The image forming apparatus according to claim 1, wherein, when the gutter area and the image area overlap, the control means outputs a message indicating this with an informing means.

4. The image forming apparatus according to claim 3, further comprising a first selecting means which allows, when the gutter area and the image area overlap, a user to choose whether or not all pages of the read image data arc subjected to actual-size printing,
wherein the control means prints all pages of the image data at an actual size when actual-size printing is selected with the first selecting means.

5. The image forming apparatus according to claim 3 further comprising a second selecting means which allows, when the gutter area and the image area overlap, a user to choose whether all pages of the read image data are subjected to reduced-size printing or only an overlapping page is subjected to reduced-size printing,
wherein the control means prints all pages of the image data at a reduced size, or prints the overlapping page at a reduced size and prints pages that do not overlap at an actual size, according to a result of selection with the second selection means.

6. The image forming apparatus according to claim 5, wherein a reduction percentage is indicated on a page of the image data printed at the reduced size.

7. An image forming method comprising:
a reading step of reading by a reading means image data of an original to be read;
a specifying step of specifying by an image-area specifying means an image area from the read image data;
a printing step of printing by a printing means the image data;
a post-processing step of subjecting, by a post-processing apparatus, recording paper to post-processing after completion of printing; and
a judging step,
wherein when post-processing is requested, before the post-processing step is performed, the image data of the entire original is read in the reading step, the image area of the read image data is specified in the specifying step, and it is judged in the judging step whether or not the specified image area overlaps a gutter area.

8. An image forming program for letting a computer execute each step of the image forming method according to claim 7.

9. A computer-readable recording medium on which the image forming program according to claim 8 is recorded.

10. The image forming apparatus according to claim 4 further comprising a second selecting means which allows, when the gutter area and the image area overlap, a user to choose whether all pages of the read image data are subjected to reduced-size printing or only an overlapping page is subjected to reduced-size printing, wherein the control means prints all pages of the image data at a reduced size, or prints the overlapping page at a reduced size and prints pages that do not overlap at an actual size, according to a result of selection with the second selection means.
